(19) United States
(12) Patent Application Publication
(10) Pub. No.: US 2009/0075194 A1
(43) Pub. Date: Mar. 19, 2009

(54) DEVELOPING AGENT, METHOD FOR MANUFACTURING A DEVELOPING AGENT, AND IMAGE FORMING APPARATUS

(75) Inventors: Takahiro Nakajima, Kanagawa-ken (JP); Tsutomu Katsumata, Shizuoka (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/207,276

(22) Filed: Sep. 9, 2008

Related U.S. Application Data
(60) Provisional application No. 60/972,468, filed on Sep. 14, 2007.

(51) Int. Cl. G03G 9/087; G03G 5/00

(52) U.S. Cl. 430/109.4; 430/137.15

(57) ABSTRACT

A developing agent includes a toner particle containing a binder resin including a first polyester resin synthesized from an aromatic monomer and an aliphatic monomer blended with a molar ratio in an alcohol component being satisfied with the relationship of {(aromatic monomer)>(aliphatic monomer)≧0} and with a molar ratio in an acid component being satisfied with the relationship of {(aliphatic monomer)>(aromatic monomer)}, a release agent, and a coloring agent.

### CROSS-REFERENCE TO RELATED APPLICATION

This application is based upon and claims the benefit of priority from the prior U.S. Patent Application No. 60/972,468 filed on Sep. 14, 2007, the entire contents of which are incorporated herein by reference.

### TECHNICAL FIELD

The present invention relates to a developing agent a method for manufacturing a developing agent, and an image forming apparatus to be used in forming an image by an electrophotographic system, for example, copiers and printers.

### BACKGROUND

In general, in an image forming apparatus using an electrophotographic system, a toner is conveyed via a conveyance medium including an electrostatic latent image carrier such as a photoconductor and an intermediate transfer medium such as a transfer belt and deposited at a desired position on a transfer medium such as paper. The toner is then subjected to contact bonding by heat rollers or the like and fixed onto the transfer medium, thereby forming an image on the transfer medium.

In recent years, in an image forming apparatus, realization of high-speed output printing (high-speed fixing) and energy conservation (low-temperature fixing) is required. Then, studies are made for improving fixing offset properties of a toner onto a transfer medium (ensuring a non-offset temperature region) In order to improve the fixing offset properties, it is necessary to design the generation temperature of a low-temperature offset phenomenon wherein a toner which is not melted because sufficient heat was not applied stains a contact member on a level as low as possible. Furthermore, it is necessary to design the generation temperature of a high-temperature offset phenomenon wherein heat of more than the necessity is supplied, whereby the toner viscosity (internal cohesive force) is lowered on a level as high as possible.

In order to improve the low-temperature offset properties, in general, it is effective to lower a glass transition point (Tg) or a softening point (Tm) of a binder resin. However, when Tg is too low, storage properties at a high temperature are deteriorated, and flow properties of a toner are lowered. Since charge properties of the toner are deteriorated due to the influence of flow properties of the toner, an image quality of an output print is lowered.

On the other hand, in order to improve the high-temperature offset properties, it is effective to devise to make the kind and addition amount of a wax as a release agent appropriate. When the amount of the wax increases, release properties from a contact member are improved, and non-offset properties are enhanced. However, when the amount of the wax is increased, the flow properties of the toner are lowered, and the storage properties at a high temperature are deteriorated. Also, it is effective to increase the viscosity (internal cohesive force) of the binder resin at melting by increasing a molecular weight of the resin to raise Tm. However, when Tm of the binder resin is excessively raised, the whole of the toner is not sufficiently melted at fixing so that the surface of the fixed toner becomes rough. Because of this influence, gloss of the toner is deteriorated, and a lowering of the color image quality is generated.

In improving the fixing offset properties (ensuring a non-offset temperature region), image quality (gloss) and storage properties at a high temperature are in a tradeoff relation to each other, and all of them cannot be satisfied.

A method for improving fixing offset properties or gloss is disclosed in JP-A-2000-347451, JP-A-2000-347460, JP-A-2001-51450, etc. In these patent documents, it is disclosed to specify the molecular weight and the kind of a monomer of a polyester resin which is a binder resin in the toner and further to add a polyolefin based wax as a release agent in the toner.

However, there is involved a problem that only by these methods, it is impossible to cope with requirement such as realization of high-speed output printing (high-speed fixing) or energy conservation (low-temperature fixing).

### SUMMARY

According to an embodiment of the invention, there is provided a developing agent including a toner particle containing a binder resin including a first polyester resin synthesized from an aromatic monomer and an aliphatic monomer blended with a molar ratio in an alcohol component being satisfied with the relationship of {(aromatic monomer)>(aliphatic monomer)≧0} and with a molar ratio in an acid component being satisfied with the relationship of {(aliphatic monomer)>(aromatic monomer)}, a release agent, and a coloring agent.

According to an embodiment of the invention, there is provided a process for manufacturing a developing agent including an aromatic monomer and an aliphatic monomer blended with a molar ratio in an alcohol component being satisfied with the relationship of {(aromatic monomer)>(aliphatic monomer)≧0} and with a molar ratio in an acid component being satisfied with the relationship of {(aliphatic monomer)>(aromatic monomer)}, to synthesize a first polyester resin, and mixing at least the first polyester resin, a release agent and a coloring agent to form a toner particle.

Also, according to an embodiment of the invention, there is provided an image forming apparatus for forming an image onto a transfer medium including a image carrier for forming a toner image by toner particles, the toner particle including a binder resin containing a first polyester resin synthesized from an aromatic monomer and an aliphatic monomer blended with a molar ratio in an alcohol component being satisfied with the relationship of {(aromatic monomer)>(aliphatic monomer)≧0} and with a molar ratio in an acid component being satisfied with the relationship of {(aliphatic monomer)>(aromatic monomer)}, a release agent; and a coloring agent.

It is to be understood that both the foregoing general description and the following detailed description are exemplary and explanatory only and are not restrictive of the invention, as claimed.

### DESCRIPTION OF THE DRAWINGS

The accompanying drawings, which are incorporated in and constitute a part of this specification, illustrate an embodiment of the invention and together with the description, serve to explain the principles of the invention.

FIG. 1 is a conceptual view of an image forming apparatus by a two-component development process in an embodiment of the invention;

FIG. 2 is a conceptual view of an image forming apparatus by a cleanerless process in an embodiment of the invention;

FIG. 3 is a conceptual view of an image forming apparatus by a quadruple tandem process in an embodiment of the invention;

FIG. 4 is a conceptual view of an image forming apparatus by a quadruple tandem process provided with an intermediate transfer medium in an embodiment of the invention; and

FIG. 5 is a table showing compositions of toner particles and evaluation results in Examples and Comparative Examples in an embodiment of the invention.

### DETAILED DESCRIPTION

Reference will now be made in detail to the present embodiment of the invention, an example of which is illustrated in the accompanying drawings.

The developing agent of the present embodiment includes a toner particle containing a binder resin including a first polyester resin synthesized from an aromatic monomer and an aliphatic monomer blended so as to be a molar ratio in an alcohol component being satisfied with the relationship of {(aromatic monomer)>(aliphatic monomer)≧0} and to be a molar ratio in an acid component being satisfied with the relationship of {(aliphatic monomer)>(aromatic monomer)}, a release agent, and a coloring agent.

The process for manufacturing a developing agent of the present embodiment includes an aromatic monomer and an aliphatic monomer blended so as to be a molar ratio in an alcohol component being satisfied with the relationship of {(aromatic monomer)>(aliphatic monomer)≧0} and to be a molar ratio in an acid component being satisfied with the relationship of {(aliphatic monomer)>(aromatic monomer)}, to synthesize a first polyester resin, and mixing at least the first polyester resin, a release agent and a coloring agent to form a toner particle.

Also, the image forming apparatus of the present embodiment is an image forming apparatus for forming an image onto a transfer medium including a image carrier for forming a toner image by toner particles, the toner particle including a binder resin containing a first polyester resin synthesized from an aromatic monomer and an aliphatic monomer blended so as to be a molar ratio in an alcohol component being satisfied with the relationship of {(aromatic monomer)>(aliphatic monomer)≧0} and to be a molar ratio in an acid component being satisfied with the relationship of {(aliphatic monomer)>(aromatic monomer)}, a release agent; and a coloring agent.

Here, the binder resin to be contained in the toner particle contains a polyester resin and preferably contains this as the major component. The polyester resin is classified into an acid component and an alcohol component, each of which is constituted of an aromatic monomer and an aliphatic monomer. In general, the aromatic monomer is a high-Tg component, and the aliphatic monomer is a low-Tg component.

Specifically, a bisphenol based monomer is exemplified as a representative aromatic monomer of the alcohol based component, and ethylene glycol is exemplified as an aliphatic monomer of the alcohol based component. On the other hand, terephthalic acid (hereinafter referred to as “TPA”) is exemplified as a representative aromatic monomer of the acid component, and fumaric acid (hereinafter referred to as “FA”) is exemplified as an aliphatic monomer of the acid component. The present inventors paid attention to these aromatic monomers and aliphatic monomers and made experimental inspections and considerations, leading to obtaining the following knowledge.

As to the alcohol component, when a proportion of a high-Tg aromatic monomer is larger than that of an aliphatic monomer, not only fixing properties but durability of the toner is excellent. The durability of the toner as referred to herein is durability of the toner against a load to be applied during the use.

For example, in a two-component development system as described later, a developing agent formed by mixing a toner and a carrier is charged in a development unit having a magnet roller. A mechanical and thermal stress is applied in a process for stirring the developing agent so that when the durability of the toner is weak, the toner is easily crushed in the development unit. Furthermore, the crushed toner firmly deposits on the carrier to cover the surface, thereby lowering charge performance of the carrier. The high-Tg aromatic monomer has sufficient durability against such a load.

On the other hand, as to the alcohol component, though the use of an aliphatic monomer leads to an improvement of fixability, the durability of the toner is deteriorated. In the alcohol component, it is effective that an aromatic monomer is used alone, or an aliphatic monomer is used in a smaller molar ratio than an aromatic monomer.

As to the acid component, it is preferable to use a large amount of an aliphatic monomer as a low-Tg component. By using a large amount of the aliphatic monomer as a low-Tg component, ideal properties such that the generation temperature of low-temperature offset is low, that the generation temperature of high-temperature offset is high and that the gloss is satisfactory are obtainable.

When a design is made so as to have the same Tm, it is possible to add a low-Tg aliphatic monomer in a larger amount as compared with a high-Tg aromatic monomer. That is, it is possible to increase the number average molecular weight. In the thus designed resin, a large amount of the low-Tg aliphatic monomer exists in the molecular chain. Since the molecular chain moves at low energy, it is possible to lower the fixing temperature. The fixing surface becomes smooth due to the matter that the toner particles are thoroughly melted, and the gloss is enhanced. An intermolecular cohesive force of the molecular chains each other at melting becomes large due to the matter that the number average molecular weight becomes large, and the generation temperature of high-temperature offset can be increased.

As the polyester resin, a linear polyester resin can be used. At the synthesis of a polyester resin, an extremely small amount of a crosslinking agent may be added. Such a linear polyester resin (hereinafter referred to as “resin A”) can be used together with a crosslinked polyester resin (hereinafter referred to as “resin B”).

At that time, it is preferable that the resin B to be used jointly has a higher softening point (Tm) than the resin A. A blending ratio of the resin A to the resin B is preferably from 60/40 to 90/10. When the blending ratio of the resin A is less than 60%, the generation temperature of low-temperature offset becomes high, whereas when it exceeds 90%, the generation temperature of high-temperature offset becomes low. The blending ratio of the resin A to the resin B is more preferably from 70/30 to 85/15.

Similar to the resin A, it is preferable that a molar ratio in the alcohol component of the resin B is satisfied with the relationship of {(aromatic monomer)>(aliphatic monomer)≧0}. It is effective that the acid component of the resin B is constituted of three kinds of an aromatic monomer, an aliphatic monomer and a crosslinking agent.

By using a crosslinking agent, the high-temperature offset properties are enhanced, and for example, when a toner is manufactured by pulverization, pulverization properties are enhanced. When the acid component of the resin B is constituted of only an aromatic monomer and a crosslinking agent, for example, tribasic trimellitic acid, Tg becomes excessively high, whereby the low-temperature fixability is deteriorated. By further adding a low-Tg aliphatic monomer, good balance of offset properties can be taken. As the crosslinking agent to be used in a trace amount to the resin B or resin A, a tribasic or polybasic acid, for example, tribasic trimellitic acid and a trihydric or higher alcohol can be used.

As a raw material monomer of the polyester, a monomer constituting a dihydric or higher alcohol component or a dibasic or polybasic acid component such as carboxylic acids, carboxylic acid anhydrides and carboxylic acid esters is useful.

As to the monomer constituting a dihydric alcohol component, examples of aromatic monomers include alkylene oxide adducts of bisphenol A, for example, polyoxypropylene(2.2)-2,2-bis(4-hydroxyphenyl)propane, polyoxypropylene(3.3)-2,2-bis(4-hydroxyphenyl)propane, polyoxyethylene(2.0)-2,2-bis(4-hydroxyphenyl)propane, polyoxypropylene(2.0)-polyoxyethylene(2.0)-2,2-bis(4-hydroxyphenyl)propane and polyoxypropylene(6)-2,2-bis(4-hydroxyphenyl)propane, bisphenol A and hydrogenated bisphenol A.

Examples of aliphatic monomers include, for example, ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol and polytetramethylene glycol.

Of these monomers constituting a dihydric alcohol component, preferred examples of the aromatic monomer to be used include bisphenol A-alkylene (having 2 or 3 carbon atoms) oxide adducts (average addition molar number: 1 to 10), bisphenol A and hydrogenated bisphenol A; and preferred examples of the aliphatic monomer to be used include ethylene glycol, propylene glycol and 1,6-hexanediol.

As to the monomer constituting a trihydric or higher alcohol component, examples of aromatic monomers include 1,3,5-trihydroxymethylbenzene; and examples of aliphatic monomers include, for example, sorbitol, 1,2,3,6-hexanetetrole, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane and trimethylolpropane.

Of these monomers constituting a trihydric or higher alcohol component, preferred examples of the aromatic monomer to be used include sorbitol, 1,4-sorbitan, pentaerythritol, glycerol and trimethylolpropane.

In the present embodiment, these monomers constituting a dihydric alcohol component and a trihydric or higher alcohol component can be used singly or in combination. It is especially preferable that a bisphenol A-alkylene (having 2 or 3 carbon atoms) oxide adduct (average addition molar number: 1 to 10) is used as the major component in the aromatic monomer.

As to the monomer constituting a dibasic acid component (carboxylic acid component), examples of aliphatic monomers include maleic acid, fumaric acid, citraconic acid, itaconic acid, gluconic acid, cyclohexanedicarboxylic acid, succinic acid, adipic acid, sebacicacid, azelaicacid, malonic acid, alkenylsuccinic acids such as n-dodecenylsuccic acid, alkylsuccinic acids such as n-dodecylsuccinic acid, and acid anhydrides or lower alkyl esters thereof. Examples of aromatic monomers include phthalic acid, isophthalic acid, terephthalic acid, and acid anhydrides or lower alkyl esters thereof.

Of these monomers constituting a dibasic acid component (carboxylic acid component), preferred examples of the aromatic monomer to be used include terephthalic acid; and preferred example of aliphatic monomer to be used include maleic acid, fumaric acid and succinic acid substituted with an alkenyl group having from 2 to 20 carbon atoms.

As to the monomers constituting a tribasic or polybasic acid component (carboxylic acid component), examples of aromatic monomers include 1,2,4-benzenetricarboxylic acid, 2,5,7-naphthalenetricarboxylic acid, 1,2,4-naphthalenetricarboxylic acid and pyromellitic acid, for example. Examples of aliphatic monomers include 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, enpole trimer acid, and acid anhydrides or lower alkyl esters thereof.

Of these monomers constituting a tribasic or polybasic acid component (carboxylic acid component), preferred examples of the aromatic monomer to be used include, for example, 1,2,4-benzenetricarboxylic acid (trimellitic acid) and an acid anhydride; and preferred examples of the aliphatic monomer to be used include alkyl (having from 1 to 12 carbon atoms) esters.

In the present embodiment, these monomers constituting a dibasic acid and a tribasic or polybasic acid can be used singly or in combination. It is especially preferable that fumaric acid or succinic acid substituted with an alkenyl group having from 2 to 20 carbon atoms or an alkyl (having from 1 to 12 carbon atoms) ester, all of which are a dibasic acid component (carboxylic acid component), is used as the major component in the aliphatic monomer; or that terephthalic acid or 1,2,4-benzenetricarboxylic acid (trimellitic acid) or an acid anhydride thereof, all of which are a tribasic or polybasic acid component (carboxylic acid component), is used as the major component in the aromatic monomer.

In polymerizing the foregoing raw material monomers of polyester, in order to accelerate the reaction, a catalyst is properly used. As the catalyst, those which are usually used, for example, dibutyltin oxide, a titanium compound, an dialkoxytin(II), tin(II) oxide, a fatty acid tin(II), dioctanoic acid tin(II) and distearic acid tin(II) are useful.

Using such monomers, crosslinking agent and catalyst and the like, a polyester resin as the binder resin is formed. When the resin A and the resin B are used jointly, the resin A and the resin B are separately synthesized and then mixed. A mixing method is not particularly limited. Examples of the mixing method include a method of drying the respective resins and mixing them at the manufacture of a toner and a method of mixing the respective resins before drying.

In addition to the foregoing polyester resins, different polyester resins or styrene based, acrylic or styrene-acrylic copolymer based resins formed by copolymerization, cyclic olefin based resins and the like may be used jointly as the binder resin. When these are used jointly, the foregoing polyester resin and the copolymer resin are separately synthesized and then mixed. A mixing method is not particularly limited. Examples thereof include a method of drying the respective resins and mixing them at the manufacture of a toner; a method of dispersing the copolymerization based resin at the synthesis of a polyester resin and the like; and a method of chemically bonding a polyester resin.

In the present embodiment, in order to devise to realize a low viscosity of the toner and to enhance release properties, it is preferable to use a low-melting wax having a peak value of melting point in the range from 65 to 85° C. as the release agent. Examples of the wax having a low melting point include, for example, natural ester waxes such as carnauba wax and rice wax; and ester based waxes such as synthetic ester wax synthesized from a carboxylic acid and an alcohol. It is preferable to use these ester based waxes singly or in combination.

The addition amount of the release agent is preferably from 3 to 8 parts by weight based on 100 parts by weight of the binder resin. When the addition amount of the release agent is less than 3 parts by weight, since Tm of the toner becomes high, the generation temperature of low-temperature offset becomes high; and release properties from the fixing contact member are lowered so that the generation temperature of high-temperature offset becomes low, whereby a non-offset temperature region becomes narrow. When the addition amount of the release agent exceeds 8 parts by weight, toner charge properties are deteriorated due to lowering of flow properties of the toner, resulting in lowering of the image quality, and storage properties at a high temperature are deteriorated.

Examples of the coloring agent which is used in the present embodiment include, for example, carbon black which is used as a color toner application; and known pigments and dyes such as condensed polycyclic pigments, azo based pigments, phthalocyanine based pigments and inorganic pigments.

Examples of the carbon black include, for example, acetylene black, furnace black, thermal black, channel black and ketjen black. Examples of the pigment or dye include, for example, Fast Yellow G, Benzidine Yellow, Indo Fast Orange, Irgazin Red, Carmine FB, Permanent Bordeaux FRR, Pigment Orange R, Lithol Red 2G, Lake Red C, Rhodamine FB, Rhodamine B Lake, Phthalocyanine Blue, Pigment Blue, Brilliant Green B, Phthalocyanine Green and quinacridone. These materials can be used singly or in admixture.

The addition amount of the coloring agent is preferably from 4 to 10 parts by weight based on 100 parts by weight of the binder resin. When the addition amount of the coloring agent is less than 4 parts by weight, a sufficient image density is not obtainable, whereas when it exceeds 10 parts by weight, the excessive pigment is present in a large amount on the toner surface and is deposited on the photoconductor, whereby filming is easily generated.

In the present embodiment, a charge controlling agent for controlling a triboelectrostatic charge quantity or the like may be blended. As the charge controlling agent, a metal-containing azo compound is useful. In the metal-containing azo compound, complexes or complex salts in which a metal element thereof is iron, cobalt or chromium, or mixtures thereof are desirable. Besides, as the charge controlling agent, a metal-containing salicylic acid derivative compound or a metal oxide hydrophobilized material is useful. In the metal-containing salicylic acid derivative compound or metal oxide hydrophobilized material, complexes or complex salts in which a metal element thereof is zirconium, zinc, chromium or boron, or mixtures thereof are desirable.

Furthermore, in the present embodiment, in order to stabilize fluidity, charge properties or storage properties of the toner particle to be formed, it is preferable that the toner particle surface has an external additive composed of a fine particle compound.

It is preferable that this external additive contains at least two kinds of inorganic compound fine particles having a different average primary particle size. As the inorganic compound, inorganic oxides such as silica, titania, alumina, strontium titanate and tin oxide are favorable. From the viewpoint of an enhancement of environmental stability, it is preferable that such an inorganic compound fine particle is subjected to a surface treatment with a hydrophobic agent. In addition to such an inorganic compound fine particle, a resin fine particle of not larger than 1 μm may be externally added.

In particular, it is preferable that the external additive composed of a fine particle compound contains three kinds of (A) a monodispersed fine particle having an average primary particle size of from 50 to 180 nm, (B) a hydrophobilized silica fine particle having an average primary particle size of 5 to 80 nm and (C) a hydrophobilized metal oxide fine particle having an average primary particle size of from 5 to 150 nm. By using a combination of the external additive composed of the fine particle compounds (A), (B) and (C), it is possible to improve the low-temperature fixing properties, storage properties, charge properties and flow properties of the toner.

For example, materials obtained by hydrophobilizing silica close to a sphere as prepared in a wet type method, fine particles of various resins and the like can be used as the monodispersed fine particle (A) having an average primary particle size of from 50 to 180 nm. The monodispersed fine particle as referred to herein means a fine particle capable of being dispersed on the toner surface in a spherical shape wherein particles are not coagulated or in a shape close to a sphere.

By adding the monodispersed fine particle (A), it is possible to improve storage properties of toner and transfer properties of toner, namely transfer properties from a photoconductor onto a transfer medium. Such a particle can be uniformly deposited on the toner surface. Even when the toner surface is softened by heat, it exists without being buried on the toner surface, thereby preventing deposition and coagulation of the toner particles each other.

When the particle size is less than 50 nm, a sufficient spacer effect between a toner particle and a toner particle or between a toner particle and a carrier cannot be obtained. On the other hand, when the particle size exceeds 180 nm, while the spacer effect is high, the toner fluidity is deteriorated. The particle size of the monodispersed fine particle (A) is more preferably from 80 to 150 nm. Furthermore, it is preferable that the particle shape is spherical. This is because the particle easily moves on the toner surface, and an effect for preventing coagulation of the toners each other becomes high.

As the hydrophobilized silica fine particle (B) having an average primary particle size of 5 to 80 nm, hydrophobilized silica manufactured by, for example, a vapor phase method can be used. In general, a silica particle prepared by the vapor phase method is present as a non-dispersible aggregate in which some primary particles are linked. The terms “5 to 80 nm” as referred to herein do not refer to the size of this aggregate but mean the primary particle size.

By adding the silica fine particle (B), the fluidity of or charge properties of the toner particle can be improved. In particular, when combined with the external additive (A), the effect to be brought by adding the silica fine particle (B) can be enhanced. The silica fine particle (B) can be used in admixture of two or more kinds thereof.

When the particle size of the silica fine particle (B) is less than 5 nm, the silica fine particle (B) exists without being buried on the toner surface so that it is difficult to fulfill a function as the external additive. On the other hand, when the particle size exceeds 80 nm, the effect for improving the toner fluidity, or charge properties becomes low. The particle size of the silica fine particle (B) is more preferably from 17 to 30 nm.

As the hydrophobilized metal oxide fine particle (C) having an average primary particle size of from 5 to 150 nm, for example, titanium oxide or aluminum oxide can be used. In particular, hydrophobilized titanium oxide or hydrophobilized aluminum oxide or the like manufactured by a vapor phase method or a wet type method can be used.

In general, titanium oxide or aluminum oxide manufactured by a vapor phase method or a wet type method is present as a non-dispersible aggregate in which some primary particles are linked. The terms “5 to 150 nm” as referred to herein do not refer to the size of this aggregate but mean the primary particle size.

By adding the hydrophobilized metal oxide fine particle (C), it becomes possible to suppress the charge quantity rise in a low-humidity circumstance to be caused due to the addition of the silica fine particle (B). In general, the silica fine particle (B) is higher in resistance than a toner particle in which the external additive is not added. That is, though a toner particle having the silica fine particle (B) added therein has high charge holding capability, when continuously used in a low-humidity circumstance, the charge quantity easily rises. When the charge quantity excessively rises, a lowering of the image density is caused. A toner particle with a high charge quantity covers a carrier so that a toner particle to be supplied cannot sufficiently achieve triboelectrostatic charge with the carrier, thereby causing a problem of the generation of a fogged image, etc.

The metal oxide fine particle (C) such as hydrophobilized titanium oxide or aluminum oxide is lower in resistance than the silica fine particle (B). It is possible to suppress the rise of the charge quantity in a low-humidity circumstance by combining the metal oxide fine particle (C) with the silica fine particle (B). The metal oxide fine particle (C) can also be used in admixture of two or more kinds thereof.

When the particle size of the metal oxide fine particle (C) is less than 5 nm, similar to the silica fine particle (B), it becomes difficult that the metal oxide fine particle (C) exists without being buried on the toner particle surface to fulfill a function as the external additive. Also, when the particle size exceeds 150 nm, the toner fluidity is deteriorated, and the metal oxide fine particle (C) is easily separated from the toner surface because of its low resistance. The particle size of the metal oxide fine particle (C) is more preferably from 10 to 50 nm.

By specifying the monomer components of the binder resin of the toner particle, more preferably regulating Tg at from 50 to 64° C. and Tm at from 100 to 120° C., respectively, it becomes possible to obtain a toner particle which is able to fix at a low temperature and has a wide non-offset region and high gloss and which even when allowed to stand at a high temperature, has excellent storage properties and charge properties without causing a change in toner properties. Furthermore, by making the formulation each of the releasing agent and the external additive appropriate, a toner particle having more satisfactory properties is obtainable.

In the image formation, such a toner particle enables one to cope with requirement for energy conservation (low-temperature fixing), realization of high-speed color outputting (high-speed fixing) and realization of high image quality of color outputting (enhancement of gloss and enlargement of a color reproduction region). Furthermore, it is possible to cope with high speed and long life (low costs) by a cheap fixing unit which is free from a mechanism for cleaning an offset image.

The toner particle can be formed by a known method including a chemical manufacturing method such as pulverization and polymerization. In the pulverization, after mixing, kneading and pulverizing raw materials including the foregoing binder resin, release agent and coloring agent, the pulverized mixture is classified, and the external additive is added to form a toner particle.

As to a device for mixing and dispersing the raw materials, for example, a mixing machine, a kneading machine or the like is useful. Examples of the mixing machine include, for example, a Henschel mixer (manufactured by Mitsui Mining Co., Ltd.); a super mixer (manufactured by Kawata Mfg., Co., Ltd.); Ribocone (manufactured by Okawara Mfg., Co., Ltd.); a nauta mixer, a turbulizer and a cyclomixer (all of which are manufactured by Hosokawa Micron Corporation); a spiral pin mixer (manufactured by Pacific Machinery & Engineering Co., Ltd.); and a Lodige mixer (manufactured by Matsubo Corporation). The mixing machines are used upon adding the external additive. Examples of the kneading machine include a KRC kneader-(manufactured by Kurimoto, Ltd.); a Buss Ko-kneader (manufactured by Buss); a TEM type extruder (manufactured by Toshiba Machine Co., Ltd.); a TEX two-screw kneading machine (manufactured by The Japan Steel Works, Ltd.); a PCM kneading machine (manufactured by Ikegai, Ltd.); a three-roll mill, a mixing roll mill and a kneader (all of which are manufactured by Inoue Mfg., Inc.); Kneadex (manufactured by Mitsui Mining Co., Ltd.); an MS type pressure kneader, a kneader-ruder (all of which are manufactured by Moriyama Company Ltd.); and a Banbury mixer (manufactured by Kobe Steel, Ltd.).

As to a device for coarsely pulverizing the mixture, for example, a hammer mill, a cutter mill, a jet mill, a roller mill and a ball mill can be used. As a device for fine pulverizing a coarsely pulverized material, a pulverizer is useful. Examples of the pulverizer include a counter jet mill, Micronjet and Inomizer (all of which are manufactured by Hosokawa Micron Corporation); an IDS type mill and a PJM jet pulverizer (all of which are manufactured by Nippon Pneumatic Mfg. Co., Ltd.); Crossjet Mill (manufactured by Kurimoto, Ltd.); Ulmax (manufactured by Nisso Engineering Co., Ltd.); SK Jet-O-Mill (manufactured by Seisin Enterprise Co., Ltd.); Cliptron (manufactured by Kawasaki Heavy Industries, Ltd.); and Turbo Mill (manufactured by Turbo Kogyo Co., Ltd.).

Examples of a classifier for classifying a finely pulverized material include Classiel, Micron Classifier and Spedic Classifier (all of which are manufactured by Seisin Enterprises Co., Ltd.); Turbo Classifier (manufactured by Nisshin Engineering Co., Ltd.); Micron separator, Turboplex (ATP) and TSP Separator (all of which are manufactured by Hosokawa Micron Corporation); Elbow-Jet (manufactured by Nittetsu Mining Co., Ltd.); Dispersion Separator (manufactured by Nippon Pneumatic Mfg. Co., Ltd.); and YM Microcut (manufactured by Yasukawa Shoji K.K.). Examples of a screening device for sieving coarse particles or the like include Ultra Sonic (manufactured by Koei Sangyo Co., Ltd.); Resona Sieve and Gyroshifter (all of which manufactured by Tokuju Corporation); Vibrasonic System (manufactured by Dalton Co., Ltd.); Soniclean (manufactured by Shinto Kogyo Kabushiki Kaisha); Turboscreener (manufactured by Turbo Kogyo Co., Ltd.); Microshifter (manufactured by Makino Mfg. Co., Ltd.); and a circular vibrating separator.

In the polymerization, the toner particle is formed by coarsely granulating a mixture containing a binder resin and a coloring agent and mixing it with an aqueous medium; subjecting the obtained mixed liquid to mechanical shearing; and after finely granulating, coagulating the fine particle. Furthermore, the coagulated particle may be fused, if desired.

The toner particle is used singly as a single-component developing agent. Also, the toner particle is used as a two-component developing agent upon addition of a magnetic carrier. The magnetic carrier is constituted of a magnetic particle such as ferrite, magnetite and iron oxide, a resin particle having such a magnetic powder incorporated thereinto, or a particle prepared by coating a resin such as a fluorine based resin, a silicone based resin and an acrylic resin on at least a part of the surface of a magnetic powder, etc.

It is desirable that a volume average particle size of the magnetic carrier particle is from 20 to 100 μm. When the volume average particle size of the magnetic carrier particles is smaller than 20 μm, a magnetic force of a single particle is low so that the magnetic carrier particle is easily separated from the developing agent carried to deposit on the photoconductor, whereas when it is larger than 100 μm, a magnetic brush becomes hard so that a brush mark appears on the image, or the toner cannot be minutely fed. The volume average particle size of the magnetic carrier particle is preferably from 30 to 60 μm.

It is desirable that a volume average particle size of the toner particle is from 3 to 8 μm. When the volume average particle size of the toner particle is smaller than 3 μm, if a charge quantity sufficient for controlling an electric field is given to each toner particle, the charge quantity per the weight becomes excessively large so that it is difficult to obtain a desired developing amount. When the volume average particle size of the toner particle is larger than 8 μm, reproducibility of a high-definition image or graininess is deteriorated. The volume average particle size of the toner particle is more preferably from 4 to 6 μm.

As an image carrier (electrostatic latent carrier) which is used in an image forming apparatus for forming an image on a transfer medium using a toner particle, known photoconductors such as OPC (organic photoconductor) of plus charge or minus charge and amorphous silicon. In these photoconductors, even when a charge generation layer, a charge transport layer and a protective layer may be stacked, or a layer having a function of plural layers of these layers may be formed. The transfer medium is a medium on which an image is ultimately formed, such as paper.

An image is formed by, for example, the following electrophotographic process using such a developing agent, or an image forming apparatus.

(Two-Component Development Process)

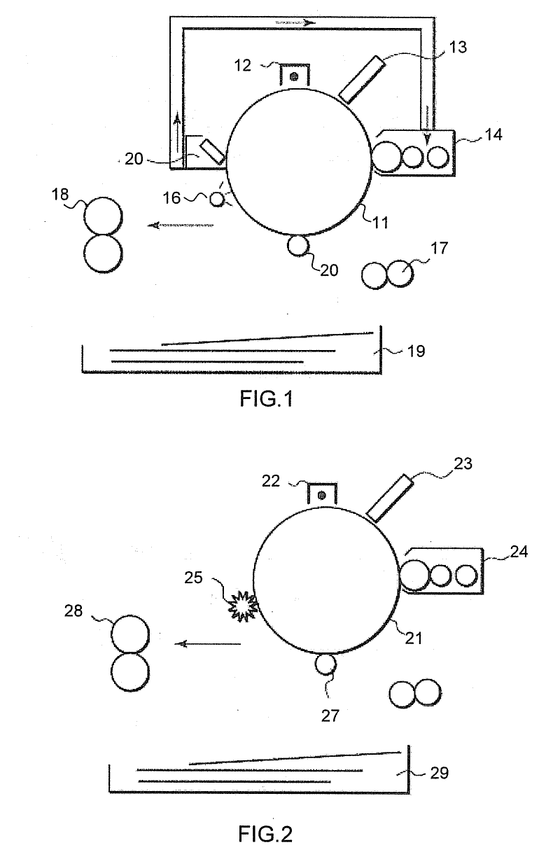

An image forming apparatus by a two-component development process is shown in FIG. 1. As shown in FIG. 1, a photoconductor 11; a charge device 12 for charging this; an exposure device 13 for forming an electrostatic latent image; a development unit 14 for feeding a toner particle to the electrostatic latent image; a cleaner 15 for removing a transfer residual toner; a destaticization lamp 16 for removing the electrostatic latent image; a paper feed device 17 for feeding paper which becomes an ultimate transfer medium; a fixing unit 18 for fixing a toner image on paper; and a transfer device 20 for transferring the toner image on the photoconductor 11 onto a transfer medium 19 are disposed. An image is formed on the transfer medium 19 using such an image forming apparatus in the following steps.

The photoconductor 11 such as a belt and a roller is uniformly at a desired potential by the known charge device 12 such as a charge wire, a comb-shaped charger, a corona charger such as a scorotron, a contact charge roller, a non-contact charge roller, a solid charger and a contact charge brush.

For the photoconductor 11, known photoconductors such as OPC (organic photoconductor) of plus charge or minus charge and amorphous silicon are useful. In these photoconductors, even when a charge generation layer, a charge transport layer and a protective layer may be stacked, or a layer having a function of plural layers of these layers may be formed.

An electrostatic latent image is formed on the photoconductor 11 upon exposure by the exposure device 13 using a known measure such as a laser and LED.

In the development unit 14, a two-component developing agent composed of a carrier and a toner particle is contained in an amount of, for example, from 100 g to 700 g within a hopper. The developing agent is conveyed into a magnetic roller-included development roller by an agitating auger. A charged toner particle is fed to and deposited on the electrostatic latent image on the photoconductor 14 by means of a magnetic brush phenomenon, thereby visualizing the electrostatic latent image. At that time, in order to form an electric field so as to deposit the toner particle uniformly and stably, DC or a development bias with AC superimposed on DC is applied to the development roller.

The toner particle not developed is separated from the developing roller in a peeling pole position of the magnetic roller and collected in a developing agent storage by the agitating auger. A known toner density sensor is installed in the developing agent storage. When the density sensor detects a decrease in an amount of toner, a signal is sent to a toner supply hopper, and a new toner is supplied. At that time, the amount of toner consumption may be estimated from integration of printing data or/and detection of the amount of development toner on the photoconductor, thereby supplying the new toner on the basis thereof. In addition, a measure for estimating both a sensor output and the amount of consumption may be used.

The formed toner image is transferred onto the transfer medium 19 such as paper through an intermediate transfer medium such as a belt or a roller or directly using a known transfer measure such as a transfer roller, a transfer blade and a corona charger, which is disposed in contact with the photoconductor 11 and which transfers the toner image by a transfer voltage to be applied herein.

The transfer medium 19 having the toner image transferred thereonto is peeled from the intermediate transfer medium or the photoconductor 11, conveyed to the fixing part 18, fixed by a known heating and press fixing measure such as a heat roller and discharged outside the machine.

After the toner image is transferred, a transfer residual toner not transferred and remaining on the photoconductor 11 is removed by the cleaner 15. The electrostatic latent image on the photoconductor 11 is erased by the destaticization lamp 16.

The transfer residual toner removed by the cleaner 15 is stored in a waste toner box and then discharged through a conveyance path by the agitating auger or the like. In a recycle system, the transfer residual toner is collected in the developing agent storage of the development unit 14 from the conveyance path and reused.

(One-Component Development Process)

In a one-component development process, an image is formed in the same manner by the same image forming apparatus as in the two-component development process. However, a development unit portion is different. Only a toner particle is stored in the development unit and developed without using a carrier.

The toner particle is supplied by a known structure such as a conveying auger and an intermediate conveying sponge roller onto the surface of a developing agent carrier such as an elastic roller having a conductive rubber layer on the surface thereof and a metal roller of SUS or the like provided with roughness on the surface thereof by sandblast or the like. The toner particle supplied onto the surface of the developing agent carrier is subjected to triboelectrostatic charge by a toner charging member such as a silicon rubber, a fluorocarbon rubber and a metal blade contact-bonded on the surface of the developing agent carrier. At that time, the toner having been previously charged by friction with a magnetic particle may be fed to the developing agent carrier itself. The photoconductor is opposed in contact with the developing agent carrier or in non-contact with the developing agent carrier with a defined gap. The photoconductor and the developing agent carrier rotate with a speed difference, whereby the toner particle is developed. At that time, in order to form an electric field so as to deposit the toner particle uniformly and stably, DC or a development bias with AC superimposed on DC is applied to the development roller.

(Cleanerless Process)

In a cleanerless process, an image is formed in the same manner by the same image forming apparatus as in the two-component development process. However, as shown in FIG. 2, the cleanerless process is different from the two-component development process in that a cleaner is not provided. A transfer residual toner is collected simultaneously with development without using a cleaner.

Similar to the two-component development process, an photoconductor 21 is charged and exposed, a toner particle is deposited thereon and developed, and a toner image is transferred onto a transfer medium 29 via an intermediate transfer medium or directly. In FIG. 2, a direct transfer method is employed, thereby achieving transfer by a transfer roller 27. A transfer residual toner remaining in a non-image area is kept remaining on the photoconductor 21 and conveyed to a development region again through steps of destaticization, charge by a charge device 22 and exposure by an exposure device 23. The transfer residual toner is collected in a development unit 24 by a magnetic brush serving as a developing agent carrier and developed anew.

At that time, before or after the destaticization step, a memory disturbing member 25 such as a fixed brush, felt, a rotating brush and a lateral sliding brush may be disposed. A temporary collection member may be disposed, thereby collecting the transfer residual toner once, releasing again it on the photoconductor 21 again and then collecting in the development unit 24. Furthermore, a toner charge device may be disposed on the photoconductor 21 in order to make an amount of charges of the transfer residual toner equal to the desired value. Furthermore, one member may carry out a part or all of the roles of the toner charging device, the memory disturbing member, the temporary collection member and the charge device. A positive or negative DC or AC voltage may be applied to these members for the purpose of efficiently carrying out the functions.

For example, tips of two lateral sliding brushes which carry out all the three roles are provided between the transfer region and the charge member of the photoconductor 21 so as to come into contact with the photoconductor 21. A voltage of the same polarity as in the development toner charge is applied to the brush on the upstream side, and a voltage of the opposite polarity from the development toner charge is applied to the brush on the downstream side.

A toner of the opposite polarity and a toner of the same polarity having an extremely high charge are mixed in the transfer residual toner. The toner of the opposite polarity coming into contact with the brush of the same polarity slips through the brush with a charge thereof reversed or is collected by the brush once. The transfer residual toner reaching the brush of the opposite polarity downstream from the brush of the same polarity has entirely the same polarity as in the development toner. When the transfer residual toner comes into contact with the brush of the opposite polarity, since a strong charge of the same polarity is relaxed, the transfer residual toner slips through the brush or is collected by the brush once.

The transfer residual toner, which has been adjusted to a low amount of charges and has lost an image structure because of mechanical contact of the brush, is charged together with the photoconductor 21 by the charging member of the photoconductor 21 in a non-contact manner and adjusted to an amount of charges in just the same amount as in the development toner. Consequently, in the development region, the transfer residual toner in a non-image portion in a new latent image is collected in the development unit 24. The transfer residual toner in an image portion is directly transferred to the transfer medium together with toner particles supplied from the development unit 24 anew.

The transfer medium 29 having the toner image transferred thereonto is peeled from the intermediate transfer medium or the photoconductor 21, conveyed to the fixing part 28, fixed by a known heating and press fixing measure such as a heat roller and discharged outside the machine.

(Quadruple Tandem Process)

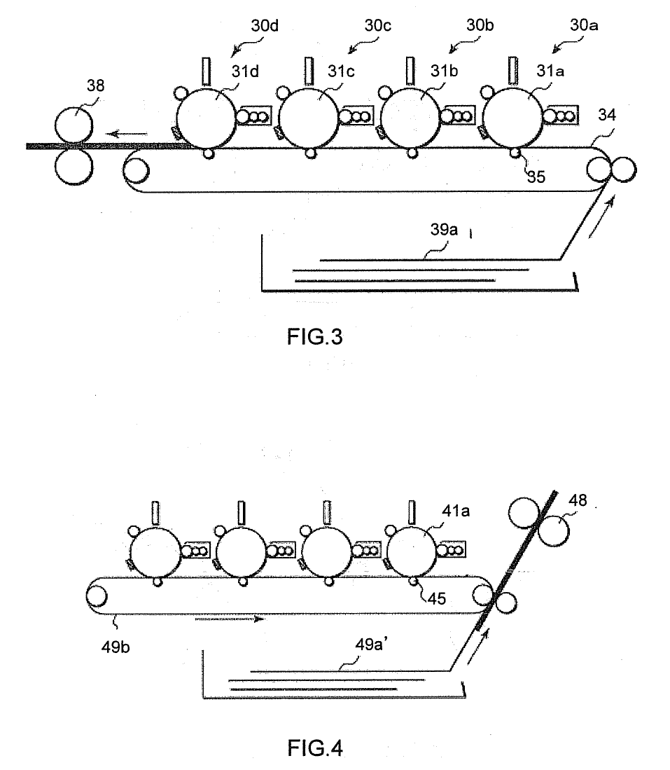

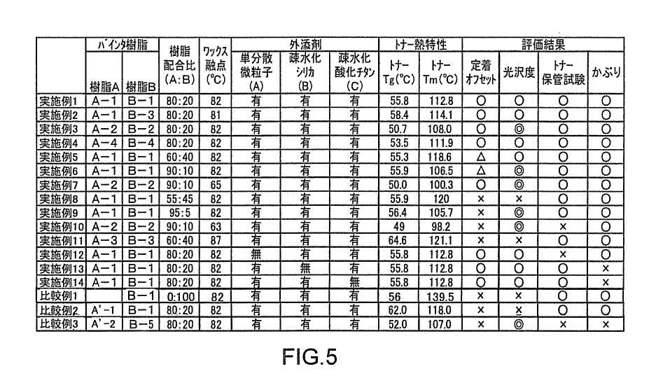

An image forming apparatus according to a quadruple tandem process is shown in FIG. 3. As shown in FIG. 3, image forming units 30a, 30b, 30c and 30d for four colors including development units containing toner particles of colors of yellow, magenta, cyan and black, respectively, photoconductors and charging, exposing and development devices are provided and arranged in parallel along a conveyance path for a transfer medium 39a. Similar to FIG. 1, a fixing device 38 for fixing a toner image on paper is arranged. An image is formed according to steps described below using such an image forming apparatus. In an example explained below, the colors are arranged in the order of yellow, magenta, cyan and black.

In the yellow image forming unit, a yellow toner image is formed on the photoconductor 31a and transferred onto the transfer medium 39a. In case of direct transfer, paper or the like serving as an ultimate transfer medium is conveyed by a conveying member such as a transfer belt and a roller and fed to a transfer region of the yellow image unit. In FIG. 3, a configuration in which transfer is carried out on paper conveyed by a transfer belt 34 as the conveyance member by a transfer roller 35 is shown. A volume resistance of the transfer belt is desirably from 10⁷ Ωcm to 10¹² Ωcm. A rubber material such as an ethylene-propylene rubber (EPDM) and chloroprene rubber (CR) or a resin material such as polyimides, polycarbonates, polyvinylidene difluoride (PVDF) and ethylenetetrafluoroethylene (ETFE) is used for the transfer belt. The transfer belt can be formed in various configurations in which a resin sheet, a rubber elastic layer, a protective layer, etc. are formed as a single layer or stacked in two or more layers. As the transfer system, it is possible to use a known transfer measure such as a transfer roller, a transfer blade and a corona charger.

In the transfer position, a transfer bias voltage with prescribed size and polarity is fed by a transfer bias power device from the transfer roller 35 provided such that the transfer belt 34 coming into contact with the photoconductor 31a is pressed on the side of the photoconductor 31a to the transfer medium 39a positioned between the transfer belt 34 and the photoconductor 31a. When this transfer bias voltage is applied, an electrostatically deposited toner image (toner) on the outer periphery of the photoconductor 31a is drawn to and transferred onto the transfer medium 39a.

As shown in FIG. 4, an intermediate transfer belt 49b may be provided as the intermediate transfer medium. The intermediate transfer belt 49b has semi-conductivity; a resin or a rubber or a stacked member thereof having a thickness of from 50 to 3,000 μm is used; and a transfer roller 45 (transfer measure) is brought into contact with a back surface side opposing to the side of the photoconductor 41a. A prescribed transfer bias voltage is applied to the transfer roller 45 by a transfer bias voltage applying part, whereby a transfer electric field is applied to a transfer nip part where the photoconductor 41a and the intermediate transfer belt 49b come into contact with each other or the surroundings thereof.

In the present embodiment, the transfer belt 45 using a semiconductor sponge having a volume resistivity of from 10⁵ Ωcm to 10⁹ Ωcm is brought into contact with the back surface of the belt, and DC of from 300 V to 3,000 V is applied, whereby the toner image on the photoconductor of each of the process units is transferred onto the intermediate transfer belt 49b. By arranging four of such process units and performing superimposing transfer, a full-color image is formed. Thereafter, the image is transferred onto a transfer medium 49a′ such as paper in a secondary transfer position and heated for fixing by a fixing unit 48 to form an ultimate image.

As to the intermediate transfer belt, one having the same material and configuration as in the foregoing transfer belt 34 is useful. Its surface resistance is desirably from 10⁷ Ωcm to 10¹² Ωcm, for example, 10⁹ Ωcm.

In the magenta image forming unit 30b, similarly, a magenta toner image is formed on a photoconductor 31b, the transfer medium 39a having a yellow toner image already transferred thereon is fed into the transfer region of the magenta image forming unit 30b, and the magenta toner image is transferred from the top of the yellow toner image with a position of the magenta toner image adjusted to a position of the yellow toner image. At this time, the yellow toner on the conveyance medium may be inversely transferred onto the magenta photoconductor 31b depending on the amount of the toner charge and the intensity of a transfer electric field by the contact with the magenta photoconductor 31b.

In the cyan and black image forming units 30c and 30d, similarly, toner images are formed and sequentially transferred to be superimposed on the transfer medium 39a. Similarly, the toner at the preceding stage may be inversely transferred onto cyan and black photoconductors 31c and 31d, respectively.

The transfer medium 39a having the toners of the four colors superimposed thereon is peeled from the conveyance member, conveyed to the fixing unit 38 to have the toners fixed thereon by a known heating and press fixing system such as a heat roller, and discharged to the outside of the machine. When the intermediate transfer medium 49b is used (FIG. 4), the toner images of the four colors are collectively transferred onto the ultimate transfer medium 49a′ such as paper supplied by secondary transfer measure. Thereafter, the ultimate transfer medium 49a′ is conveyed to the fixing unit 48 to have the toner images fixed thereon in the same manner and discharged to the outside of the machine.

In the respective image forming units, as in the two-component development process, the photoconductors 31a, 31b, 31c and 31d are subjected to destaticization to have a transfer residual toner and an inversely transferred toner removed in a cleaning step and then return to the image formation process. In the development unit, a toner specific density is adjusted as in the two-component development process described above. In the example explained above, the image forming units are arranged in the order of colors of yellow, magenta, cyan and black. However, the order of colors is not particularly limited.

(Quadruple Tandem Cleanerless Process)

In a quadruple tandem cleanerless process, an image is formed in the same manner by the same image forming apparatus as the quadruple tandem process. Similar to the foregoing cleanerless process, the quadruple tandem cleanerless process is different from the quadruple tandem process in that a cleaner is not provided. A transfer residual toner and an inversely transferred toner are collected after the amount of charge is adjusted simultaneously with development without using a cleaner.

The embodiment is specifically described below with reference to the following Examples. Here, Tm of each of resins and toner particles were measured by employing a temperature rise method. A constant load extrusion type capillary rheometer “CFT-500D” (manufactured by Shimadzu Corporation) was used as a measurement device under the following conditions. Sample: 1.5 g, starting temperature: 40° C., ultimate temperature: 200° C., temperature rise rate: 2.5° C./min, load: 10 kgf/cm², preheating time: 300 s, die hole size: 1 mm, and die length: 1 mm.

Tg of each of binder resins and toners and a melting point of each of release agents (waxes) were measured by using a differential thermal balance (“Thermo Plus 2”, manufactured by Rigaku Corporation). That is, a temperature difference was measured by using 20 mg of a sample and alumina as a reference material; heating the sample to 200° C. under a condition at a temperature rise rate of 10° C./min and a measurement temperature of from 20 to 200° C.; cooling it to not higher than 20° C.; and again heating it. As to Tg of each of the binder resins and the toners, tangent lines were drawn on a low-temperature side and a high-temperature side of a curve generated in the vicinity of from 40 to 70° C., and a point of intersection on the extension lines thereof was defined as Tg of the resin and toner. Also, a maximum endothermic peak generated at 60° C. or higher was defined as a melting point of the release agent (wax).

A particle size distribution measuring device (BECKMAN COULTER COUNTER MULTISIZER 3) was used for the measurement of the toner particle. A laser diffraction scattering particle size distribution analyzer “LA910” (manufactured by Horiba, Ltd.) was used for the measurement of a primary average particle size of an external additive.

(Synthesis Examples of Polyester Resins)

Raw materials including monomers were introduced into a 3-liter four-necked flask. The four-necked flask was installed with a reflux condenser, a water separating device, a nitrogen introducing pipe, a stainless steel-made stirrer and a thermometer. The raw materials were heated at 180 to 220° C. in an electric heating mantle; nitrogen was poured thereinto; stirring was performed; and a reaction was achieved while making, as an estimate, a softening point measured by a ring and ball method, thereby obtaining polyester resins (resins A-1 to A-4 and B-1 to B-5). The resins A-1 to B-5 are as follows. (A numerical value in each of the brackets expresses a molar ratio.)

### Resin A-1

A polyester resin synthesized from a propylene oxide adduct of bisphenol A [40], an ethylene oxide adduct of bisphenol A [70], terephthalic acid [30] and fumaric acid [70] (Tg: 57.4° C., Tm: 105.0° C.)

### Resin A-2

A polyester resin synthesized from a propylene oxide adduct of bisphenol A [35], an ethylene oxide adduct of bisphenol A [75], terephthalic acid [10] and fumaric acid [90] (Tg: 52.8° C., Tm: 102.4° C.)

### Resin A-3

A polyester resin synthesized from a propylene oxide adduct of bisphenol A [50], an ethylene oxide adduct of bisphenol A [60], terephthalic acid [45] and fumaric acid [55] (Tg: 64.3° C., Tm: 111.1° C.)

### Resin A-4

A polyester resin synthesized from a propylene oxide adduct of bisphenol A [40], an ethylene oxide adduct of bisphenol A [60], polypropylene glycol [10], terephthalic acid [30] and fumaric acid [70] (Tg: 55.0° C., Tm: 104.5° C.)

### Resin B-1

A polyester resin synthesized from a propylene oxide adduct of bisphenol A [70], an ethylene oxide adduct of bisphenol A [25], terephthalic acid [60], a succinic acid derivative [15] and trimellitic anhydride [10] (Tg: 56.8° C., Tm: 149.6° C.)

### Resin B-2

A polyester resin synthesized from a propylene oxide adduct of bisphenol A [75], an ethylene oxide adduct of bisphenol A [25], terephthalic acid [60], a succinic acid derivative [18] and trimellitic anhydride [12] (Tg: 53.0° C. Tm: 140.7° C.)

### Resin B-3

A polyester resin synthesized from a propylene oxide adduct of bisphenol A [75], an ethylene oxide adduct of bisphenol A [25], terephthalic acid [70], a succinic acid derivative [12] and trimellitic anhydride [8] (Tg: 61.4° C., Tm: 158.1° C.)

### Resin B-4

A polyester resin synthesized from a propylene oxide adduct of bisphenol A [70], an ethylene oxide adduct of bisphenol A [20], propyleneglycol [10], terephthalic acid [65], a succinic acid derivative [15] and trimellitic anhydride [10] (Tg: 55.9° C., Tm: 147.3° C.)

### Resin B-5

A polyester resin synthesized from a propylene oxide adduct of bisphenol A [30], an ethylene oxide adduct of bisphenol A [10], propyleneglycol [50], terephthalic acid [55], a succinic acid derivative [15] and trimellitic anhydride [10] (Tg: 52.5° C., Tm: 139.8° C.)

Similarly, a resin A′-1 in which a molar ratio in the alcohol component has the relationship {(aromatic monomer)>(aliphatic monomer)≧0}, whereas a molar ratio in the acid component is reverse to the resin A and has the relationship of {(aromatic monomer)>(aliphatic monomer)} was obtained.

### Resin A′-1 (Originally Resin A-5)

A polyester resin synthesized from a propylene oxide adduct of bisphenol A [50], an ethylene oxide adduct of bisphenol A [60], terephthalic acid [55] and fumaric acid [45] (Tg: 64.9° C., Tm: 112.6° C.)

Similarly, a resin A′-2 in which a molar ratio in the alcohol component is reverse to the resin A and has the relationship {(aliphatic monomer)>(aromatic monomer)}, whereas a molar ratio in the acid component has the relationship of {(aliphatic monomer)>(aromatic monomer)} was obtained.

### Resin A′-2

A polyester resin synthesized from a propylene oxide adduct of bisphenol A [30], an ethylene oxide adduct of bisphenol A [20], polypropylene glycol [60], terephthalic acid [30] and fumaric acid [70] (Tg: 53.2° C., Tm: 103.0° C.)

Each of the thus obtained polyester resins (resins A-1 to B-5) was used as a binder resin to form toner particles of the following Examples 1 to 16.

### EXAMPLE 1

The following materials were blended in a ratio described below.

| | |
|---|---|
| Binder resin (Resin A-1/Resin B-1: | 87 parts by weight |
| 80/20): | |
| Wax (carnauba wax, melting point: 82° C.): | 6 parts by weight |
| Coloring agent (MA-100): | 6 parts by weight |
| Antistatic agent (metal-containing | 1 part by weight |
| salicylic acid derivative): | |

These materials were mixed in a Henschel mixer and then melt kneaded by a twin-screw extruder. The obtained melt kneaded material was cooled and then coarsely pulverized by a hammer mill; and subsequently, the coarsely pulverized material was finely pulverized by a jet pulverizer and classified to obtain a powder (toner particle before external addition) having a volume average size of 7 μm, a toner Tg of 55.8° C. and a toner Tm of 112.8° C.

External additives were added to 100 parts of this powder. As the external additives, 1 part by weight of monodispersed hydrophobic silica as a monodispersed inorganic fine particle compound having an average primary particle size of 100 nm, 1 part by weight of hydrophobic silica having an average primary particle size of 30 nm and 0.5 parts by weight of hydrophobic titanium oxide having an average primary particle size of 20 nm were used. The powder and the external additives were thrown into a Henschel mixer and mixed to externally add the external additives to the powder, thereby forming a toner particle.

The obtained toner particle was stirred in a proportion of 6 parts by weight based on 100 parts by weight of a ferrite carrier having a surface coated with a silicone resin having an average particle size of 40 μm in a tumbler mixer, thereby obtaining a developing agent.

The obtained developing agent was evaluated in the following manners.

[Evaluation of Fixing Offset]

In a fixing system obtained by modifying a commercially available “e-studio 3510c” (manufactured by Toshiba Tec Corporation) so as to increase a fixing process speed two times, solid images with a toner deposition amount of 1.6 mg/cm² were subjected to paper-passing while changing a fixing temperature at 5° C. intervals within the range of from 110 to 200° C., and whether or not offset was generated was visually evaluated, thereby defining a temperature at which image peeling was generated as a generation temperature of low-temperature offset and a temperature at which roughness could be distinctly confirmed on the image surface as a generation temperature of high-temperature offset. A temperature at which this low-temperature offset and high-temperature offset was not generated was defined as a non-offset region temperature; and the case where the subject temperature is 35° C. or higher was designated as “◯”, the case where it is 25° C. or higher and lower than 35° C. was designated as “Δ” (Δ and higher were defined to be “pass”), and the case where it is lower than 25° C. was designated as “X”, respectively.

[Evaluation of Glossiness]

A data obtained by measuring the solid image obtained in the evaluation of fixing offset at a measurement angle of 60 degrees using a gloss meter “VG-2000” (manufactured by Nippon Denshoku Industries Co., Ltd.) is defined as glossiness. The case where the glossiness is less than 13 was designated as “X”, the case where it is 13 or more and less than 18 was designated as “◯”, and the case where it is 18 or more was designated as “⊚”, respectively.

[Toner Storage Test]

20 g of a toner is sealed in a plastic container and allowed to stand in a thermostat set up at 55° C. for 8 hours. After taking out from the thermostat, the toner was spontaneously cooled for 12 hours or more, then placed on a screen having an opening of 42 mesh using a powder tester (manufactured by Hosokawa Micron Corporation) and vibrated at a scale of 4 for 10 seconds. The case where the residual amount of the toner on the screen is less than 5 g was designated as “◯”, and the case where it is 5 g or more was designated as “X”, respectively.

[Evaluation of Fog]

A white paper image was copied, and a copy image was measured using a spectrophotometer “CM-503c” (manufactured by Minolta Camera Co., Ltd.). The case of not more than 1.50% was designated as “◯”, and the case of 1.51% or more was designated as “X”, respectively.

The results of these evaluations are shown in Table 1. As shown in Table 1, satisfactory results were obtained in the respective evaluations.

### EXAMPLE 2

The following materials were blended in a ratio described below.

| | |
|---|---|
| Binder resin (Resin A-1/Resin B-3: | 87 parts by weight |
| 80/20): | |
| Wax (rice wax, melting point: 81° C.): | 6 parts by weight |
| Coloring agent (MA-100): | 6 parts by weight |
| Antistatic agent (metal-containing | 1 part by weight |
| salicylic acid derivative): | |

These materials were processed in the same manner as in Example 1 to obtain a powder having a volume average size of 7 μm, a toner Tg of 58.4° C. and a toner Tm of 114.1° C. External additives were added to the powder in the same manner as in Example 1, thereby forming a toner particle. A developing agent was prepared from the obtained toner particle in the same manner as in Example 1 and similarly evaluated. The evaluation results are also shown in Table 1. As shown in Table 1, satisfactory results were obtained in the respective evaluations.

### EXAMPLE 3

The following materials were blended in a ratio described below.

| | |
|---|---|
| Binder resin (Resin A-2/Resin B-2: | 87 parts by weight |
| 80/20): | |
| Wax (carnauba wax, melting point: 82° C.): | 6 parts by weight |
| Coloring agent (MA-100): | 6 parts by weight |
| Antistatic agent (metal-containing | 1 part by weight |
| salicylic acid derivative): | |

These materials were processed in the same manner as in Example 1 to obtain a powder having a volume average size of 7 μm, a toner Tg of 50.7° C. and a toner Tm of 108.0° C. External additives were added to the powder in the same manner as in Example 1, thereby forming a toner particle. A developing agent was prepared from the obtained toner particle in the same manner as in Example 1 and similarly evaluated. The evaluation results are also shown in Table 1. As shown in Table 1, satisfactory results were obtained in the respective evaluations.

### EXAMPLE 4

The following materials were blended in a ratio described below.

| | |
|---|---|
| Binder resin (Resin A-4/Resin B-4: | 87 parts by weight |
| 80/20): | |
| Wax (carnauba wax, melting point: 82° C.): | 6 parts by weight |
| Coloring agent (MA-100): | 6 parts by weight |
| Antistatic agent (metal-containing | 1 part by weight |
| salicylic acid derivative): | |

These materials were processed in the same manner as in Example 1 to obtain a powder having a volume average size of 7 μm, a toner Tg of 53.5° C. and a toner Tm of 111.9° C. External additives were added to the powder in the same manner as in Example 1, thereby forming a toner particle. A developing agent was prepared from the obtained toner particle in the same manner as in Example 1 and similarly evaluated. The evaluation results are also shown in Table 1. As shown in Table 1, satisfactory results were obtained in the respective evaluations.

### EXAMPLE 5

The following materials were blended in a ratio described below.

| | |
|---|---|
| Binder resin (Resin A-1/Resin B-1: | 87 parts by weight |
| 60/40): | |
| Wax (carnauba wax, melting point: 82° C.): | 6 parts by weight |
| Coloring agent (MA-100): | 6 parts by weight |
| Antistatic agent (metal-containing | 1 part by weight |
| salicylic acid derivative): | |

These materials were processed in the same manner as in Example 1 to obtain a powder having a volume average size of 7 μm, a toner Tg of 55.3° C. and a toner Tm of 118.6° C. External additives were added to the powder in the same manner as in Example 1, thereby forming a toner particle. A developing agent was prepared from the obtained toner particle in the same manner as in Example 1 and similarly evaluated. The evaluation results are also shown in Table 1. As shown in Table 1, satisfactory results were obtained in the respective evaluations.

### EXAMPLE 6

The following materials were blended in a ratio described below.

| | |
|---|---|
| Binder resin (Resin A-1/Resin B-1: | 87 parts by weight |
| 90/10): | |
| Wax (carnauba wax, melting point: 82° C.): | 6 parts by weight |
| Coloring agent (MA-100): | 6 parts by weight |
| Antistatic agent (metal-containing | 1 part by weight |
| salicylic acid derivative): | |

These materials were processed in the same manner as in Example 1 to obtain a powder having a volume average size of 7 μm, a toner Tg of 55.9° C. and a toner Tm of 106.5° C. External additives were added to the powder in the same manner as in Example 1, thereby forming a toner particle. A developing agent was prepared from the obtained toner particle in the same manner as in Example 1 and similarly evaluated. The evaluation results are also shown in Table 1. As shown in Table 1, satisfactory results were obtained in the respective evaluations.

### EXAMPLE 7

The following materials were blended in a ratio described below.

| | |
|---|---|
| Binder resin (Resin A-2/Resin B-2: | 88 parts by weight |
| 90/10): | |
| Wax (synthetic ester wax, melting | 5 parts by weight |
| point: 65° C.): | |
| Coloring agent (MA-100): | 6 parts by weight |
| Antistatic agent (metal-containing | 1 part by weight |
| salicylic acid derivative): | |

These materials were processed in the same manner as in Example 1 to obtain a powder having a volume average size of 7 μm, a toner Tg of 50.0° C. and a toner Tm of 100.3° C. External additives were added to the powder in the same manner as in Example 1, thereby forming a toner particle. A developing agent was prepared from the obtained toner particle in the same manner as in Example 1 and similarly evaluated. The evaluation results are also shown in Table 1. As shown in Table 1, satisfactory results were obtained in the respective evaluations.

### EXAMPLE 8

The following materials were blended in a ratio described below.

| | |
|---|---|
| Binder resin (Resin A-1/Resin B-1: | 87 parts by weight |
| 55/45): | |
| Wax (carnauba wax, melting point: 82° C.): | 6 parts by weight |
| Coloring agent (MA-100): | 6 parts by weight |
| Antistatic agent (metal-containing | 1 part by weight |
| salicylic acid derivative): | |

These materials were processed in the same manner as in Example 1 to obtain a powder having a volume average size of 7 μm, a toner Tg of 55.9° C. and a toner Tm of 120° C. External additives were added to the powder in the same manner as in Example 1, thereby forming a toner particle. A developing agent was prepared from the obtained toner particle in the same manner as in Example 1 and similarly evaluated. The evaluation results are also shown in Table 1. As shown in Table 1, satisfactory results were obtained in the toner storage test and evaluation of fog.

### EXAMPLE 9

The following materials were blended in a ratio described below.

| | |
|---|---|
| Binder resin (Resin A-1/Resin B-1: | 87 parts by weight |
| 95/5): | |
| Wax (carnauba wax, melting point: 82° C.): | 6 parts by weight |
| Coloring agent (MA-100): | 6 parts by weight |
| Antistatic agent (metal-containing | 1 part by weight |
| salicylic acid derivative): | |

These materials were processed in the same manner as in Example 1 to obtain a powder having a volume average size of 7 μm, a toner Tg of 56.4° C. and a toner Tm of 105.7° C. External additives were added to the powder in the same manner as in Example 1, thereby forming a toner particle. A developing agent was prepared from the obtained toner particle in the same manner as in Example 1 and similarly evaluated. The evaluation results are also shown in Table 1. As shown in Table 1, satisfactory results were obtained in the evaluation of glossiness, toner storage test and evaluation of fog.

### EXAMPLE 10

The following materials were blended in a ratio described below.

| | |
|---|---|
| Binder resin (Resin A-2/Resin B-2: | 87 parts by weight |
| 90/10): | |
| Wax (carnauba wax, melting point: 63° C.): | 6 parts by weight |
| Coloring agent (MA-100): | 6 parts by weight |
| Antistatic agent (metal-containing | 1 part by weight |
| salicylic acid derivative): | |

These materials were processed in the same manner as in Example 1 to obtain a powder having a volume average size of 7 μm, a toner Tg of 49° C. and a toner Tm of 98.2° C. External additives were added to the powder in the same manner as in Example 1, thereby forming a toner particle. A developing agent was prepared from the obtained toner particle in the same manner as in Example 1 and similarly evaluated. The evaluation results are also shown in Table 1. As shown in Table 1, satisfactory results were obtained in the evaluation of glossiness and evaluation of fog.

### EXAMPLE 11

The following materials were blended in a ratio described below.

| | |
|---|---|
| Binder resin (Resin A-3/Resin B-3: | 87 parts by weight |
| 60/40): | |
| Wax (synthetic ester wax, melting | 6 parts by weight |
| point: 87° C.): | |
| Coloring agent (MA-100): | 6 parts by weight |
| Antistatic agent (metal-containing | 1 part by weight |
| salicylic acid derivative): | |

These materials were processed in the same manner as in Example 1 to obtain a powder having a volume average size of 7 μm, a toner Tg of 64.6° C. and a toner Tm of 121.1° C. External additives were added to the powder in the same manner as in Example 1, thereby forming a toner particle. A developing agent was prepared from the obtained toner particle in the same manner as in Example 1 and similarly evaluated. The evaluation results are also shown in Table 1. As shown in Table 1, satisfactory results were obtained in the toner storage test and evaluation of fog.

### EXAMPLE 12

To 100 parts of the powder as prepared in Example 1, 1 part by weight of hydrophobic silica having an average primary particle size of 30 nm and 0.5 parts by weight of hydrophobic titanium oxide having an average primary particle size of 20 nm were added as external additives in the same manner as in Example 1, thereby forming a toner particle. A developing agent was prepared from the obtained toner particle in the same manner as in Example 1 and similarly evaluated. The evaluation results are also shown in Table 1. As shown in Table 1, satisfactory results were obtained in the evaluation of fixing offset, evaluation of glossiness and evaluation of fog.

### EXAMPLE 13

To 100 parts of the powder as prepared in Example 1, 1 part by weight of a monodispersed inorganic fine particle compound having an average primary particle size of 100 nm and 0.5 parts by weight of hydrophobic titanium oxide having an average primary particle size of 20 nm were added as external additives in the same manner as in Example 1, thereby forming a toner particle. A developing agent was prepared from the obtained toner particle in the same manner as in Example 1 and similarly evaluated. The evaluation results are also shown in Table 1. As shown in Table 1, satisfactory results were obtained in the evaluation of fixing offset, evaluation of glossiness and toner storage test.

### EXAMPLE 14

To 100 parts of the powder as prepared in Example 1, 1 part by weight of a monodispersed inorganic fine particle compound having an average primary particle size of 100 nm and 1 part by weight of hydrophobic silica having an average primary particle size of 30 nm were added as external additives in the same manner as in Example 1, thereby forming a toner particle. A developing agent was prepared from the obtained toner particle in the same manner as in Example 1 and similarly evaluated. The evaluation results are also shown in Table 1. As shown in Table 1, satisfactory results were obtained in the evaluation of fixing offset, evaluation of glossiness and toner storage test.

### COMPARATIVE EXAMPLE 1

The following materials were blended in a ratio described below.

| | |
|---|---|
| Binder resin (Resin A/Resin B-1: | 87 parts by weight |
| 0/100): | |
| Wax (carnauba wax, melting point: 82° C.): | 6 parts by weight |
| Coloring agent (MA-100): | 6 parts by weight |
| Antistatic agent (metal-containing | 1 part by weight |
| salicylic acid derivative): | |

These materials were processed in the same manner as in Example 1 to obtain a powder having a volume average size of 7.8 μm, a toner Tg of 56° C. and a toner Tm of 139.5° C. External additives were added to the powder in the same manner as in Example 1, thereby forming a toner particle. A developing agent was prepared from the obtained toner particle in the same manner as in Example 1 and similarly evaluated. The evaluation results are also shown in Table 1. As shown in Table 1, satisfactory results were not obtained in the evaluation of fixing offset and evaluation of glossiness.

### COMPARATIVE EXAMPLE 2

The following materials were blended in a ratio described below.

| | |
|---|---|
| Binder resin (Resin A′-1/Resin B-1: | 87 parts by weight |
| 80/20): | |
| Wax (carnauba wax, melting point: 82° C.): | 6 parts by weight |
| Coloring agent (MA-100): | 6 parts by weight |
| Antistatic agent (metal-containing | 1 part by weight |
| salicylic acid derivative): | |

These materials were processed in the same manner as in Example 1 to obtain a powder having a volume average size of 7 μm, a toner Tg of 62° C. and a toner Tm of 118° C. External additives were added to the powder in the same manner as in Example 1, thereby forming a toner particle. A developing agent was prepared from the obtained toner particle in the same manner as in Example 1 and similarly evaluated. The evaluation results are also shown in Table 1. As shown in Table 1, satisfactory results were not obtained in the evaluation of fixing offset and evaluation of glossiness.

### COMPARATIVE EXAMPLE 3

The following materials were blended in a ratio described below.

| | |
|---|---|
| Binder resin (Resin A′-2/Resin B-5: | 87 parts by weight |
| 80/20): | |
| Wax (carnauba wax, melting point: 82° C.): | 6 parts by weight |
| Coloring agent (MA-100): | 6 parts by weight |
| Antistatic agent (metal-containing | 1 part by weight |
| salicylic acid derivative): | |

These materials were processed in the same manner as in Example 1 to obtain a powder having a volume average size of 7 μm, a toner Tg of 52.0° C. and a toner Tm of 107.0° C. External additives were added to the powder in the same manner as in Example 1, thereby forming a toner particle. A developing agent was prepared from the obtained toner particle in the same manner as in Example 1 and similarly evaluated. The evaluation results are also shown in Table 1. As shown in Table 1, satisfactory results were not obtained in the evaluation of fixing offset, evaluation of glossiness and evaluation of fog.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A developing agent comprising:
a toner particle containing a binder resin including a first polyester resin synthesized from an aromatic monomer and an aliphatic monomer blended with a molar ratio in an alcohol component being satisfied with the relationship of {(aromatic monomer)>(aliphatic monomer)≧0} and with a molar ratio in an acid component being satisfied with the relationship of {(aliphatic monomer)>(aromatic monomer)}, a release agent, and a coloring agent.

2. The developing agent according to claim 1, wherein the first polyester resin is a linear polyester resin.

3. The developing agent according to claim 1, wherein the binder resin further comprising a second polyester resin having a softening point higher than the first polyester resin, the second polyester resin being a crosslinked polyester synthesized from an aromatic monomer and an aliphatic monomer blended with a molar ratio in an alcohol component being satisfied with the relationship of {(aromatic monomer)>(aliphatic monomer)≧0} and an acid component-containing crosslinking agent.

4. The developing agent according to claim 3, wherein a blending ratio of the first polyester resin to the second polyester resin is from 60/40 to 90/10.

5. The developing agent according to claim 1, wherein the release agent contains an ester based wax having a peak value of melting point in the range of from 65 to 85° C.

6. The developing agent according to claim 1, having an external additive containing at least two kinds of inorganic compound fine particles having a different average primary particle size on the surface of the toner particle.

7. The developing agent according to claim 6, wherein the external additive contains a monodispersed fine particle having an average primary particle size of from 50 to 180 nm, a hydrophobilized silica fine particle having an average primary particle size of from 5 to 80 nm and a hydrophobilized metal oxide fine particle having an average primary particle size of from 5 to 150 nm.

8. A process for manufacturing a developing agent comprising:
an aromatic monomer and an aliphatic monomer blended with a molar ratio in an alcohol component being satisfied with the relationship of {(aromatic monomer)>(aliphatic monomer)≧0} and with a molar ratio in an acid component being satisfied with the relationship of {(aliphatic monomer)>(aromatic monomer)}, to synthesize a first polyester resin; and
mixing at least the first polyester resin, a release agent and a coloring agent to form a toner particle.

9. The process according to claim 8, wherein the first polyester resin is a linear polyester resin.

10. The process according to claim 8, further comprising mixing an aromatic monomer and an aliphatic monomer to synthesize a second polyester resin having a softening point higher than the first polyester resin, the second polyester resin being a crosslinked polyester, the aromatic monomer and the aliphatic monomer blended with a molar ratio in an alcohol component being satisfied with the relationship of {(aromatic monomer)>(aliphatic monomer)≧0}, and an acid component containing an aromatic monomer, an aliphatic monomer and a crosslinking agent;
and mixing the second polyester resin together with the first polyester, the release agent and the coloring agent.

11. The process according to claim 10, wherein a blending ratio of the first polyester resin to the second polyester resin is from 60/40 to 90/10.

12. The process according to claim 8, wherein the release agent contains an ester based wax having a peak value of melting point in the range of from 65 to 85° C.

13. The process according to claim 8, wherein an external additive containing at least two kinds of inorganic compound fine particles having a different average primary particle size is added onto the surface of the toner particle.

14. The process according to claim 13, wherein the external additive contains a monodispersed fine particle having an average primary particle size of from 50 to 180 nm, a hydrophobilized silica fine particle having an average primary particle size of from 5 to 80 nm and a hydrophobilized metal oxide fine particle having an average primary particle size of from 5 to 150 nm.

15. An image forming apparatus for forming an image onto a transfer medium comprising:
a image carrier for forming a toner image by toner particles;
wherein the toner particle including a binder resin containing a first polyester resin synthesized from an aromatic monomer and an aliphatic monomer blended with a molar ratio in an alcohol component being satisfied with the relationship of {(aromatic monomer)>(aliphatic monomer)≧0} and with a molar ratio in an acid component being satisfied with the relationship of {(aliphatic monomer)>(aromatic monomer)}; a release agent; and a coloring agent.

16. The apparatus according to claim 15, wherein the first polyester resin is a linear polyester resin.

17. The apparatus according to claim 15, wherein the binder resin further comprising a second polyester resin having a softening point higher than the first polyester resin, the second polyester resin being a crosslinked polyester synthesized from an aromatic monomer and an aliphatic monomer blended with a molar ratio in an alcohol component being satisfied with the relationship of {(aromatic monomer)>(aliphatic monomer)≧0} and an acid component-containing crosslinking agent.

18. The apparatus according to claim 17, wherein a blending ratio of the first polyester resin to the second polyester resin is from 60/40 to 90/10.

19. The apparatus according to claim 17, wherein the release agent contains an ester based wax having a peak value of melting point in the range of from 65 to 85° C.

20. The apparatus according to claim 17, having an external additive containing at least two kinds of inorganic compound fine particles having a different average primary particle size on the surface of the toner particle.
